(19) United States
(12) Patent Application Publication
(10) Pub. No.: US 2011/0143922 A1
(43) Pub. Date: Jun. 16, 2011

(54) COMPOSITION WITH CATALYST PARTICLES

(76) Inventors: Cheng-Hsien Lee, Kaohsiung County (TW); Yi-Chun Liu, Taipei County (TW)

(21) Appl. No.: 12/854,366

(22) Filed: Aug. 11, 2010

(30) Foreign Application Priority Data
Dec. 14, 2009 (TW) 098142670
Mar. 5, 2010 (TW) 099106436

(51) Int. Cl. B01J 31/06; B01J 35/00; B01J 21/06

(52) U.S. Cl. 502/159; 502/100; 502/232

(57) ABSTRACT

A composition with catalyst particles for making a circuit pattern is provided. The composition includes an insulation material and a plurality of catalyst particles. The catalyst particles are distributed in the insulation material and not made of metal. When the composition is bathed in a chemical plating solution, a redox reaction takes place between some of the catalyst particles and the chemical plating solution so as to deposit a conductive pattern on the composition.

### CROSS-REFERENCE TO RELATED APPLICATION

This application claims the benefits of Taiwan Patent Application No. 098142670, filed on Dec. 14, 2009 and Taiwan Patent Application No. 099106436, filed on Mar. 5, 2010, which are hereby incorporated by reference for all purposes as if fully set forth herein.

### BACKGROUND OF THE INVENTION

1. Field of the Invention

The present invention relates to a composition, and specifically to a composition with catalyst particles for making a circuit pattern.

2. Description of Related Art

Multilayer boards, which includes not only a plurality of circuit patterns but also at least one conductive blind via, have been developed, and the conductive blind via is electrically connected with at least two layers.

During manufacturing of the multilayer board, the circuit patterns are usually formed by lithography and etching of a copper foil on a dielectric layer. The conductive blind via is formed in the dielectric layer by following processes: laser drilling, desmear, chemical plating (also called electroless plating) and electroplating.

### SUMMARY OF THE INVENTION

An object of the invention is to provide a composition with catalyst particles for making a circuit pattern.

A composition with catalyst particles in accordance with the present invention is provided for making a circuit pattern. The composition with catalyst particles includes an insulation material and a plurality of catalyst particles. The catalyst particles are distributed in the insulation material and not made of metal. When the composition with catalyst particles is bathed in a chemical plating solution, a redox reaction (shorthand for reduction-oxidation reaction) may take place between some of the catalyst particles and the chemical plating solution so as to deposit a conductive pattern on the composition with catalyst particles.

Based on the above, the conductive pattern can be formed on the composition by the catalyst particles. Accordingly, the composition of the present invention can be applied to make a circuit pattern and suitable for making a circuit board and a molded interconnect device (MID).

To further understand the above features and advantages of the present invention, please refer to the following detailed description and drawings related the present invention.

### BRIEF DESCRIPTION OF THE DRAWINGS

FIG. 1 is a cross-sectional view of a composition with catalyst particles according to a preferred embodiment;

FIG. 2A to FIG. 2C illustrate cross-sectional diagrams for making a circuit pattern from the composition as shown in FIG. 1; and

FIG. 3A to FIG. 3B illustrate cross-sectional diagrams for making a molded interconnect device from the composition as shown in FIG. 1.

### DETAILED DESCRIPTION OF THE PREFERRED EMBODIMENTS

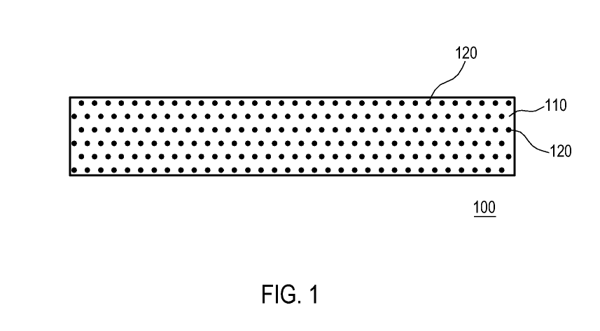

FIG. 1 is a cross-sectional view of a composition with catalyst particles according to a preferred embodiment. Referring to FIG. 1, the composition 100 includes an insulation material 100 and a plurality of catalyst particles 120. The catalyst particles 120 are distributed in the insulation material 110 and not made of metal.

Particularly, the catalyst particles 120 may be boron particles, silicon particles, germanium particles, arsenic particles, antimony particles and tellurium particles. In addition, the catalyst particles 120 may also be metalloid complex compound particles, such as metalloid nitride particles or metalloid oxide particles; moreover, the components of the catalyst particles 120 may simultaneously contain metalloid complex compounds and metalloids.

In a preferred embodiment, the diameter of the catalyst particles 120 may be greater than 100 nm, and the mass percentage of the catalyst particles 120, that is, the mass ratio of the catalyst particles 120 to the composition 100, may be between 5% and 40%. Besides, the dielectric constant of the composition 100 may be between 2.5 (1 MHz) and 4.7 (1 MHz), which is approximate to that of general epoxy resin.

The insulation material 110 may be a polymer or a ceramic, and the polymer may include epoxy resin, modified epoxy resin, polyester, acrylic ester, fluoro-polymer, polyphenylene oxide, polyimide (PI), phenolicresin, polysulfone, silicone polymer, bismaleimide triazine modified epoxy (BT resin), cyanate ester, polyethylene, polycarbonate (PC), acrylonitrile-butadiene-styrene copolymer (ABS copolymer), polyethylene terephthalate (PET), polybutylene terephthalate (PBT), liquid crystal polymers (LCP), polyamide 6 (PA 6), Nylon, polyoxymethylene (POM), polyphenylene sulfide (PPS), cyclic olefin copolymer (COC) or any combination thereof.

In addition, the insulation material 110 may be a solid material or a liquid material, so that the composition 100 is in the solid or liquid states such as a bulk/a film or a coating.

The catalyst particles 120 are incorporating into the insulation material 110 and mixing them together to form the composition 100. During the mixing stage, the catalyst particles 120 are stirred such that the catalyst particles 120 can be evenly distributed in the insulation material 110. Moreover, the composition 100 may also be formed by mixing the catalyst particles 120 with a dispersant (not shown) into a slurry in advance and then incorporating the slurry into the insulation material 110. It must be understood that the dispersant is not a required material for forming the composition 100, such that the dispersant may be used to mix with catalyst particles 120 in a preferred embodiment but not limited to the invention.

The composition 100 can be applied to make a circuit pattern for a circuit board such as a single-side circuit board, a double-side circuit board or a multilayer circuit board. In addition, the circuit pattern may also include at least one conductive blind via.

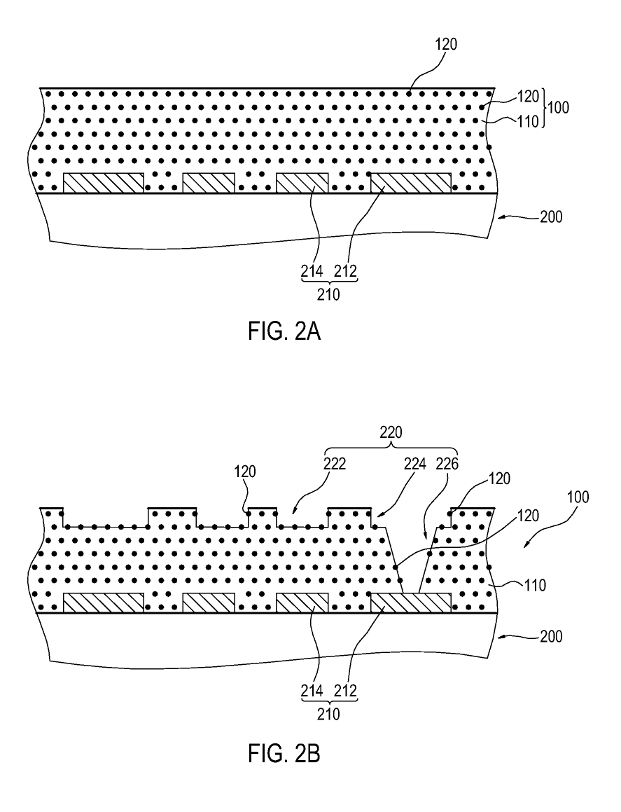

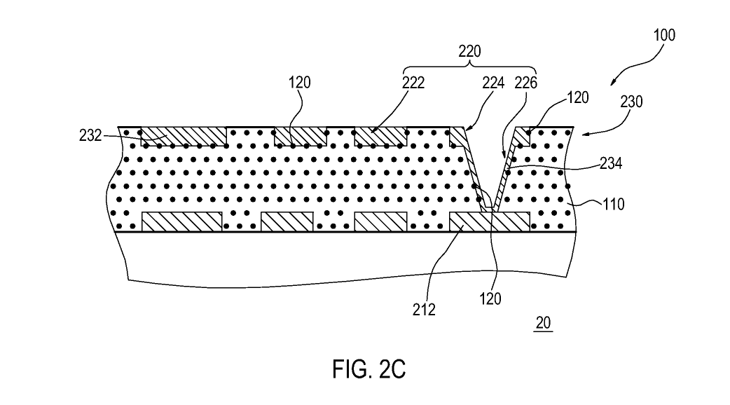

FIG. 2A to FIG. 2C illustrate cross-sectional diagrams for making a circuit pattern from the composition as shown in FIG. 1. To explain how to use the composition 100 to make the circuit pattern of the circuit board, please refer to the following detailed description in combination with the accompanying drawings.

Referring to FIG. 2A, during making the circuit board, a composition with catalyst particles 100 is formed on a substrate 200. As shown in FIG. 2A, the insulation material 110 may be a solid material or a liquid material, such that the composition 100 is made into a film or a coating. Hence, the composition 100 may be formed on the substrate 200 by means of pressing or coating.

The substrate 200 may also be a circuit substrate, a metal core layer or a resin layer. When the substrate 200 is a circuit substrate, the substrate 200 has at least one circuit pattern. Taking the substrate 200 shown in FIG. 2A for example, the substrate 200 has a circuit pattern 210 including at least one pad 212 and at least one trace 214, and the composition 100 is covered on the circuit pattern 210.

In FIG. 2A, only one circuit pattern 210 is shown, but not limited to the invention. The substrate 200 may also have a plurality of circuit patterns and at least one conductive connection structure. The conductive connection structure connects to the circuit patterns, so that at least two circuit patterns can be electrically connected to each other. In addition, the conductive connection structure may be, for example, a blind via, a through hole or a buried hole.

Referring to FIG. 2B, a recessed pattern 220 is formed on the composition 100, and some of the catalyst particles 120 are exposed on the surfaces of the recessed pattern 220. For example, the recessed pattern 220 may include at least one trench 222, at least one notch 224 and at least one blind via 226. The notch 224 is connected with the trench 222, the blind via 226 is located under the notch 224 and connected with the notch 224, and some of the catalyst particles 120 are exposed on the trench 222, the notch 224 and the blind via 226. Further, the pad 212 of the circuit pattern 210 is partially exposed from the blind via 226.

The recessed pattern 220 can be formed by several methods such as laser ablation, plasma etching or mechanical processing. A laser source used for the laser ablation may emit a laser beam with the wavelength range of visible light, infrared light or ultraviolet light. The mechanical processing may include water jet cutting, sandblasting or profile cutting such as V-cutting or routing.

It should be noted that after the recessed pattern 220 is formed by laser ablation, a desmear process is performed on the recessed pattern 220 to desmear the blind via 226 for eliminating the residues of the insulation material 110 and the impurities remained on the surface of the pad 212. Generally, the pre-process solutions used in the desmear process may slightly corrode metal surfaces, so that the pre-process solutions may slightly damage the surface of the pad 212.

On the other hand, since the catalyst particles 120 are not made of metal, the pre-process solutions are unable to damage the catalyst particles 120 exposed on the recessed pattern 220. Therefore, the catalyst particles 120 can be remained without any change in chemical properties after the desmear process.

Referring to FIG. 2C, a chemical plating process is performed, that is, the composition 100 with the catalyst particles 120 is bathed in a chemical plating solution. When the composition 100 is bathed in the chemical plating solution, a redox reaction may take place between the catalyst particles 120 exposed on the recessed pattern 220 and the chemical plating solution. Through the redox reaction, a conductive pattern 230 is formed and deposited on the composition 100, so as to cover the surfaces of the recessed pattern 220 such as the bottom surfaces and the sidewalls of the trench 222, the notch 224 and the blind via 226.

In detail, the chemical plating solution includes at least one type of metal ion, such as copper ions or nickel ions and so on. A redox reaction may take place between the surface atoms of the catalyst particles 120 and the metal ions, such that the metal ions are reduced to metal atoms which attach to the catalyst particles 120. The metal atoms are combined together to form the conductive pattern 230. Accordingly, the conductive pattern 230 is formed by the metal ions and connected with some catalyst particles 120, as shown in FIG. 2C.

To easily deposit the conductive pattern 230 on the composition 100 and improve electrical quality of the conductive pattern 230, in a preferred embodiment, the mass percentage of the catalyst particles 120 may be between 20% and 30%, and the diameter of the catalyst particles 120 may be between 300 nm and 400 nm. Furthermore, when the catalyst particles 120 are silicon particles used as an example, the preferred purity of the silicon particles may be more than 97%, so that the conductive pattern 230 may easily deposit on the composition 100 and the electrical quality of the conductive pattern 230 can also be improved.

However, it should be emphasized that the invention is not limited to any particular purity of the silicon particles. The preferred purity of the silicon particles may also be less than 97% in other preferred embodiments. Moreover, when the catalyst particles 120 are silicon particles, the catalyst particles 120 may be prepared commercially available silicon powder or ground silicon powder ground in a ball grinder.

The chemical plating solution may be an alkaline solution or an acid solution, and the alkaline solution or the acid solution can dissociate the surface atoms in the catalyst particles 120 to produce a plurality of electrons. The electrons combine with the metal ions in the chemical plating solution to produce metal atoms, thereby promoting the deposition of the conductive pattern 230 on the composition 100.

It is to be noted that after the desmear process, the catalyst particles 120 exposed on the recessed pattern 220 are still remained without any change in chemical properties, so that the deposition of the conductive pattern 230 won't be affected even if the desmear process has been performed. Besides, after the desmear process, the residues of the insulation material 110 and the impurities remained on the surface of the pad 212 are removed to ensure that the conductive pattern 230 can tightly connect to the pad 212, and the electrical connection quality of the conductive pattern 230 and the pad 212 is improved.

After the conductive pattern 230 is formed, a circuit board 20 is essentially complete, wherein the conductive pattern 230 is a circuit pattern of the circuit board 20 and may include a circuit pattern 232 and a conductive blind via 234. The circuit pattern 232 includes a plurality of traces (not labeled) and at least one pad (not labeled), and the traces are disposed in the trench 222 and the pad is disposed in the notch 224. The conductive blind via 234 is disposed in the blind via 226 and may be a hollow conductive column.

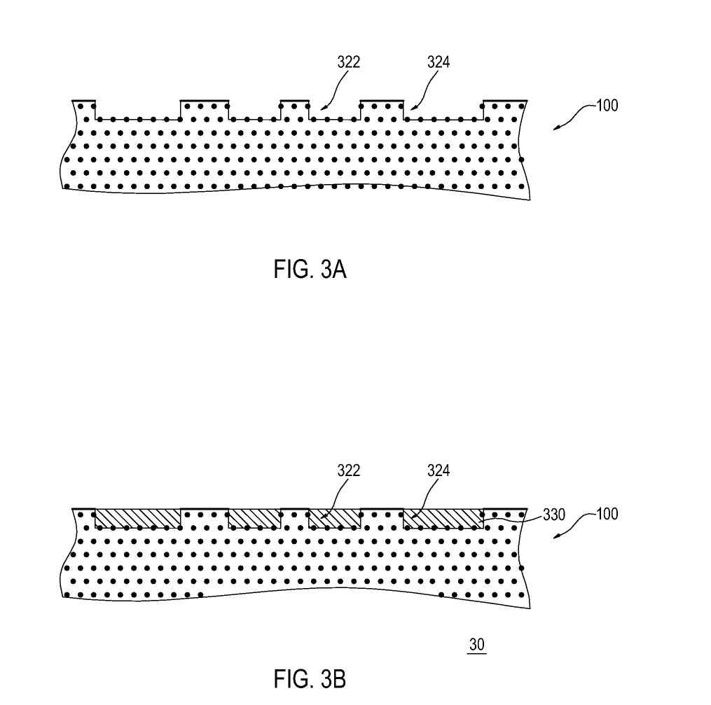

FIG. 3A to FIG. 3B illustrate cross-sectional diagrams for making a molded interconnect device (MID) from the composition as shown in FIG. 1. Referring to FIG. 3A, the composition 100 described in the preferred embodiment can be applied to make not only a circuit pattern of a circuit board but also a molded interconnect device.

In detail, during the process of making the molded interconnect device, a plurality of trenches 322 and at least one notch 324 are formed on the composition 100, and the insulation material 110 of the composition 100 is a bulk. In addition, the composition 100 may be made into a sheet or a shell for electronic apparatuses such as mobile phones, laptop computers or personal digital assistants (PDAs). The method for forming the trenches 322 and the notch 324 is the same as that of forming the recessed pattern 220 as shown in FIG. 2B, so that the description is omitted herein.

Referring to FIG. 3B, the composition 100 is bathed in a chemical plating solution, such that a redox reaction may take place between the composition 100 and the chemical plating solution to form a conductive pattern 330 in the trenches 222 and the notch 224. Since the principle of forming the conductive pattern 330 is the same as that of forming the conductive pattern 230 as shown in FIG. 2C, so that the description is omitted herein.

The conductive pattern 330 is a circuit pattern, and the conductive pattern 330 includes traces (not labeled) disposed in the trenches 322 and a pad (not labeled) disposed in the notch 324. After the conductive pattern 330 is formed on the composition 100, a molded interconnect device 30 is essentially complete. Additionally, when the composition 100 is made into a sheet, the molded interconnect device 30 may be a single-side circuit board.

To sum up, a redox reaction may take place between the chemical plating solution and the catalyst particles so as to deposit the conductive pattern such as circuit patterns or conductive blind vias on the composition. The composition of the invention can be applied to make a circuit pattern and suitable for making a circuit board or a molded interconnect device.

Additionally, the conductive pattern is only formed on the area where the catalyst particles and the chemical plating solution are brought in contact, that is, where the catalyst particles are exposed. Therefore, the invention can omit the processes of lithography and etching, and fabricate a circuit pattern completely without lithography and etching based on utilizing the composition of the invention in making circuit patterns. As a result, the invention can reduce the requirements for photoresists, developing agents and etching solutions and omit photo masks during making circuit boards, thereby reducing costs in manufacturing circuit boards.

What are disclosed above are only the specification and the drawings of the best embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A composition with catalyst particles for making a circuit pattern, comprising:
an insulation material; and
a plurality of catalyst particles, distributed in the insulation material and not made of metal, wherein when the composition is bathed in a chemical plating solution, a redox reaction takes place between some of the catalyst particles and the chemical plating solution so as to deposit a conductive pattern on the composition.

2. The composition with catalyst particles as claimed in claim 1, wherein the diameter of the catalyst particles is more than 50 nm.

3. The composition with catalyst particles as claimed in claim 1, wherein the catalyst particles are made of metalloid particles.

4. The composition with catalyst particles as claimed in claim 3, wherein the catalyst particle are a silicon particle.

5. The composition with catalyst particles as claimed in claim 1, wherein the insulation material is a polymer or a ceramic.

6. The composition with catalyst particles as claimed in claim 1, wherein the insulation material is a solid material or a liquid material.

7. The composition with catalyst particles as claimed in claim 6, wherein the solid material is a bulk or a film.

8. The composition with catalyst particles as claimed in claim 1, wherein the mass percentage of the catalyst particles is between 1% and 50%.

9. The composition with catalyst particles as claimed in claim 1, wherein a dielectric constant of the composition is between 2.5 (1 MHz) and 4.7 (1 MHz).

10. The composition with catalyst particles as claimed in claim 1, wherein the circuit pattern comprises a conductive blind via.

11. The composition with catalyst particles as claimed in claim 1, wherein the composition and the circuit pattern formed thereon form a molded interconnect device.

12. The composition with catalyst particles as claimed in claim 1, wherein the chemical plating solution is an alkaline solution.

13. The composition with catalyst particles as claimed in claim 1, wherein the chemical plating solution is an acid solution.

14. The composition with catalyst particles as claimed in claim 1, wherein the chemical plating solution comprises at least one type of metal ions and the conductive pattern is formed by the metal ions.
